(19) United States
(12) Patent Application Publication
(10) Pub. No.: US 2003/0144958 A1
(43) Pub. Date: Jul. 31, 2003

(54) Computer network based secure peer-to-peer file distribution system

(76) Inventors: Eli Entze Liang, North Potomac, MD (US); Andrei Sergeevich Mikhalchuk, Moscow (RU); Alexei Victorovich Ourivski, Moscow (RU)

Correspondence Address: DANIEL J SWIRSKY, PO BOX 2345, BEIT SHEMESH, 99544, IL

(21) Appl. No.: 10/056,114

(22) Filed: Jan. 28, 2002

(51) Int. Cl. G06F 17/60

(52) U.S. Cl. 705/51

(57) ABSTRACT

A secure peer-to-peer file distribution method including a) a buyer sending to a seller and an arbitrator a request to receive a file possessed by the seller, b) the seller sending a confirmation of the request to the arbitrator, c) the arbitrator sending encryption information to the seller, the seller d) encrypting the file with the encryption information, e) sending the encrypted file to the buyer, f) creating a first hash from the encrypted file, g) sending the first hash to the arbitrator, the buyer h) creating a second hash from the encrypted file, i) sending the second hash to the arbitrator, if the hashes match, the arbitrator j) authorizing payment from the buyer to the seller, k) sending decryption information to the buyer, and the buyer decrypting the encrypted file.

### FIELD OF THE INVENTION

The present invention is related to computer network based file distribution systems in general, and more particularly to secure peer-to-peer file distribution systems and control methods therefor.

### BACKGROUND OF THE INVENTION

The popularity of computer network based peer-to-peer file distribution systems such as Napster™ and Gnutella™ has raised concerns by copyright holders of their increasing inability to control and profit from the distribution of their software, multimedia content, and other digital content. Computer networks such as the Internet has fostered an unprecedented degree of interactivity, giving rise to rampant file sharing and infringement. Furthermore, as a digital file can be copied with no loss of fidelity, it is almost impossible to differentiate a digital copy from the digital original.

The principal technology which has been used for protecting digital content is cryptography. However, devising practical retail systems for delivery of digital content from distributor to consumer, as distinct from confidential transmission in national security and business activities among trusted and cleared personnel, has required innovation. Executable software-based cryptography can ensure that data are distributed only to authorized users. The information to be protected is encrypted and transmitted to the authorized user(s). Separately, a decryption key is provided only to authorized users. The key is subsequently used to enable decryption of the information so that it is available to the authorized user(s).

Existing methods for distributing files over computer networks suffer from a variety of problems, including their inability to guarantee delivery to of content upon payment, their inability to track the file distribution path, and their inability to prevent and/or track unauthorized redistribution. A file distribution method that overcomes these problems would, therefore, be advantageous. Furthermore, new methods of content distribution often cannot be easily integrated with existing systems of goods distribution, such as Multi-level Marketing (MLM), vendors-distributors, etc. A content distribution method that can be integrated with traditional sales methods and new distribution technologies, such as peer-to-peer, would also be advantageous.

### SUMMARY OF THE INVENTION

The present invention provides a secure computer network based peer-to-peer file distribution system that ensures that sellers of digital content will receive payment for distribution of their digital content and that buyers will receive digital content that they pay for, that prevents distribution of illegal or pirated content, that allows pirated content to be identified as such, and that prevents other transaction information, such as encryption keys, credit card numbers, etc., from being stolen by a third party during transfer.

In one aspect of the present invention a peer-to-peer file distribution method is provided including a) a buyer sending to a seller and an arbitrator a request to receive a file possessed by the seller, b) the seller sending a confirmation of the request to the arbitrator, c) the arbitrator sending encryption information to the seller, the seller d) encrypting the file with the encryption information, e) sending the encrypted file to the buyer, f) creating a first hash from the encrypted file, g) sending the first hash to the arbitrator, the buyer h) creating a second hash from the encrypted file, i) sending the second hash to the arbitrator, if the hashes match, the arbitrator j) authorizing payment from the buyer to the seller, k) sending decryption information to the buyer, and the buyer decrypting the encrypted file.

In another aspect of the present invention the method further includes in the sending step c) the arbitrator sending watermarking information to the seller, in the encrypting step d) the seller watermarking the file with the watermarking information, in the sending step e) the seller sending the encrypted and watermarked file to the buyer, in the creating step f) the seller creating a first hash from the encrypted and watermarked file, in the creating step h) the buyer creating a second hash from the encrypted and watermarked file.

In another aspect of the present invention any of the sending steps includes encrypting that which is sent with an encryption key associated with the recipient of that which is sent.

In another aspect of the present invention the method further includes any of the recipients of that which is sent in any of the sending steps decrypting that which is sent using a decryption key operative to decrypt that which is sent.

In another aspect of the present invention any of the sending steps includes signing that which is sent with a signature key associated with the sender of that which is sent.

In another aspect of the present invention the method further includes any of the recipients of that which is sent in any of the sending steps verifying the signature of that which is sent.

### BRIEF DESCRIPTION OF THE DRAWINGS

The present invention will be understood and appreciated more fully from the following detailed description taken in conjunction with the appended drawings in which:

FIG. 1 is a simplified sequence diagram of a computer network based secure peer-to-peer file distribution system, constructed and operative in accordance with a preferred embodiment of the present invention; and

FIGS. 2A, 2B, and 2C, taken together, is a simplified flowchart illustration useful in understanding the system of FIG. 1.

### DETAILED DESCRIPTION OF PREFERRED EMBODIMENTS

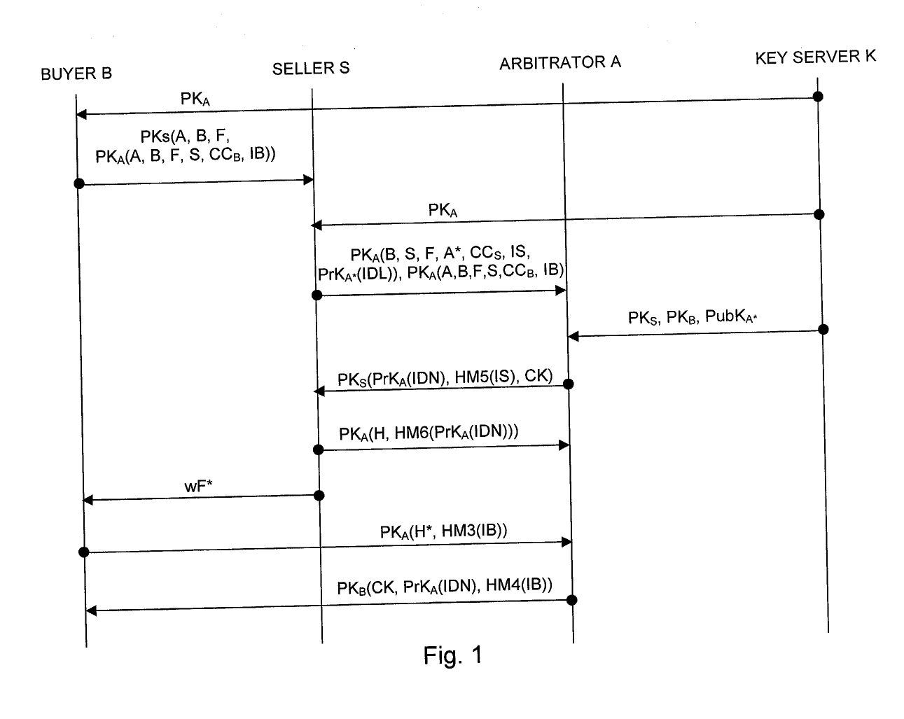

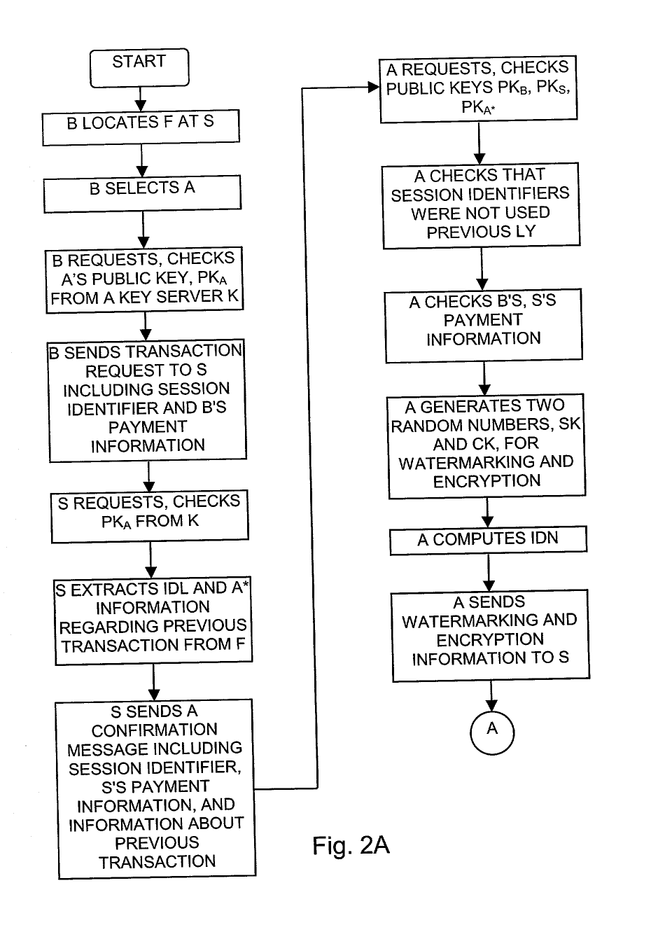

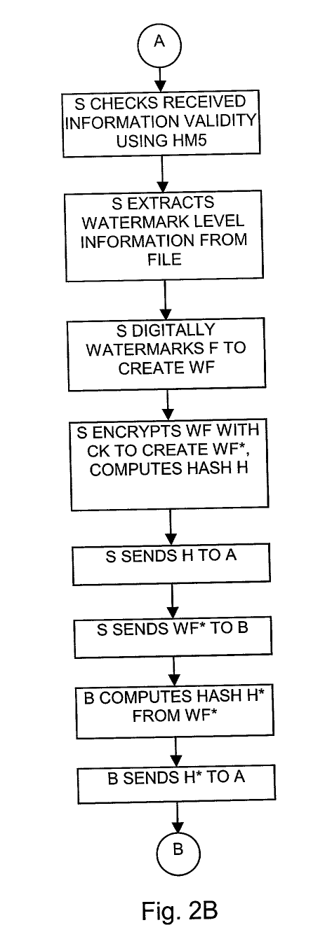

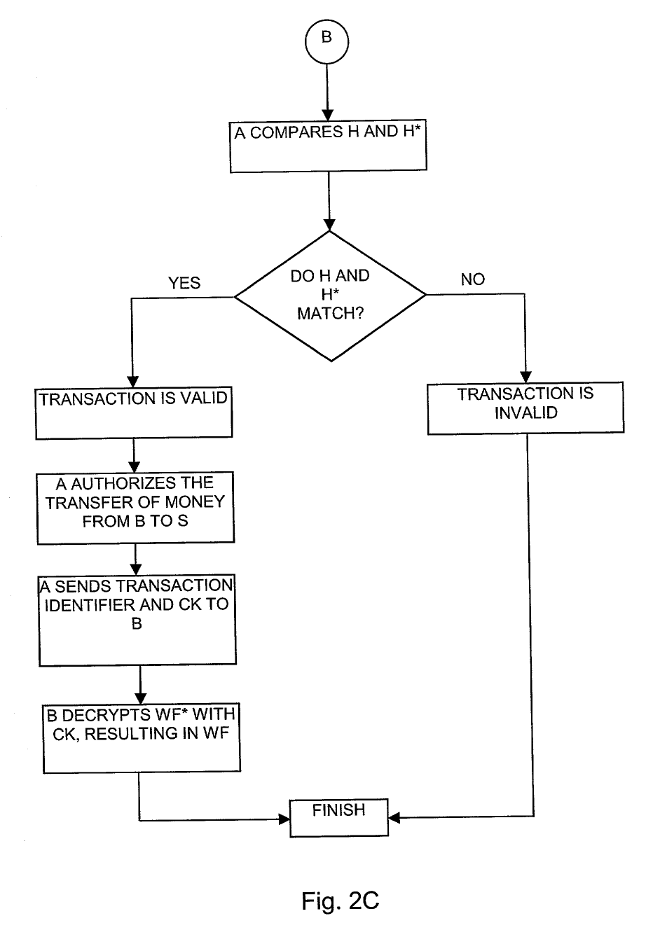

Reference is now made to FIG. 1, which is a simplified sequence diagram of a computer network based secure peer-to-peer file distribution system, constructed and operative in accordance with a preferred embodiment of the present invention, and additionally to FIGS. 2A, 2B, and 2C, which, taken together, is a simplified flowchart illustration useful in understanding the system of FIG. 1. It is appreciated that the present invention may be implemented on one or more computers connected to a computer network, such as the Internet, using conventional techniques. In the system of FIG. 1 and the method of FIGS. 2A, 2B, and 2C, a prospective buyer B of digital content, such as in the form of a computer file F, knows of or otherwise locates F as residing on a computer of a seller S. B then selects an available arbitrator A known to B or otherwise locates an available arbitrator A. B then requests A's public key, PK_{A}, typically signed by a certification authority, from a key server K, and may check the signature using conventional techniques to confirm that it is indeed A's key. B then sends a transaction request to S, optionally encrypted with PK_{S}, including an identifier identifying B, an identifier identifying A, the name of file F, and information encrypted with PK_{A}, including B's payment information, such as a credit card number CC_{B}, a randomly chosen bit sequence IB, preferably being several hundred bits long, which will serve as a session identifier, an identifier identifying B, an identifier identifying A, an identifier identifying S, and the name of file F. (It is appreciated throughout the specification and claims that the notation PKₙ is used to denote public keys used for asymmetric encryption, while PrKₙ and PubKₙ denote private and public keys respectively such as may be used in conjunction with signature and signature verification algorithms.) B's request may also be signed with PrK_{B}, B's private key, using any known signature algorithm in order to ensure that the request indeed came from B. It is appreciated that any message transmission described herein may be similarly signed using the sender's private key.

S then requests A's public key PK_{A} from K, typically signed by a certification authority, and may check the signature using conventional techniques to confirm that the key is need A's key. S then extracts identifier of the previous transaction signed by the arbitrator of the previous transaction A* that is PrK_{A}*(IDL) and also the identifier of the arbitrator of the previous transaction A*. S then generates a session identifier IS, preferably being hundreds of bits long. S then sends a request to A, typically encrypted with with PK_{A} including identifiers of B, S, file name F, S's own payment information, such as a credit card number CC_{S}, a session identifier IS, extracted IDL signed by PrK_{A}*, an identifier of A*, and, separately, identifiers of A, B, S, file name F, B's payment information CC_{B}, and B's session identifier IB encrypted with PK_{A} that S received in encrypted form from B. If there is no A*, this implies that S is the creator of F or is otherwise the source of F. If so, S may act as A* by creating an identifier IDL from F, signing it using S's private key PrK_{S}, and watermarking F. S's public key for signature verification, PubK_{S}, may be made available on key server K. Optionally, a copyright verification server may be established to determine whether F has been pirated using techniques described herein. If the file has not been pirated, then the copyright verification server may create IDL, sign it, and watermark F.

A then requests S's and B's public keys, PK_{S} and PK_{B}, from K, typically signed by a certification authority, and may check the signatures using conventional techniques to confirm that the keys are indeed S's and B's public keys. A also checks that IS and IB were not used in a previous transaction, and confirms that CC_{S} and CC_{B} is present and valid using conventional techniques. Additionally A requests PubK_{A}* from the key server and checks the validity of PrK_{A}*(IDL), thereby verifying that F is a legal file originating from a copyright holder or other authorized representative. This validation prevents pirated files from being sold within the system of the present invention. A then generates two random numbers, SK and CK, preferably being several hundred bits long each, with SK being used for generating a new transaction identifier that will be incorporated within the watermark, and CK being used as a session key for a symmetric encryption algorithm. A also calculates a new transaction IDN as the result of a hash function applied to identifiers of A, B, S, PrK_{A}*(IDL). A then sends a message, typically encrypted with PK_{S}, to S including PrK_{A}*(IDN), HM5(IS) and CK.

The function HM5( ) is a function known to A and S in advance of transaction processing. S then checks HM5(IS) to make sure he is talking to A. S then digitally watermarks F to create a digitally watermarked file wF. The watermark typically incorporates information relating to the transaction, such as IDN signed by A, identifiers for B, S, and A, and a parameter ‘Level’ that defines the ordinal number of the watermark applied to the file, as the watermarking method used preferably allows for multiple watermarks to be applied to a single file, even one on top of the other. The watermarking method used is also preferably one that makes it impossible to remove the watermark from the file without damaging the file. Any suitable watermarking technique that meets these requirements may be used. S then encrypts wF with CK using any known symmetric encryption technique to create wF* and computes a hash H from the encrypted file wF*.

S then sends a message to A, typically encrypted with PK_{A}, including H, and a value HM6(PrK_{A}(IDN)), where HM6( ) is a function known to both parties in advance of processing the transaction. S then sends wF* to B. B then computes a hash H* from wF* using the same hash algorithm used by S hereinabove. B then sends to A a message, preferably encrypted with PK_{A}, including H*, HM3(IB). HM3( ) is a function known to A and B in advance of transaction processing.

Having received a message from S, A checks HM6(PrK_{A}(IDN)) to make sure he is talking to S and extracts H. Having received a message from B, A checks HM3(IB) to make sure that he is talking to B and extracts H*. A then compares the two hashes H and H*. If they match, then the transaction is valid, and A may contact a payment authority, such as a credit card company, to authorize the transfer of money from B to S. A then sends a message to B, preferably encrypted with PK_{B}, including CK, PrK_{A}(IDN), and HM4(IB), where HM4( ) is a function known to A and B in advance of transaction processing.

Once B receives the message sent by A, B checks HM4(IB) to make sure he is talking to A. B then decrypts wF* with CK, resulting in a functional wF. B also preferably checks the PrK_{A}(IDN) received from A and the PrK_{A}(IDN) from the watermark to see if they match. If they do not match, B may report such to A. B then replaces PrK_{A}*(IDL) with PrK_{A}(IDN) in F's meta-information, as well as A* with A, and Level with Level+1.

In the system and method of FIGS. 1, 2A, 2B, and 2C, B and S preferably each possess only one public key, being PK_{A}, while A preferably possesses both PK_{S} and PK_{B}. However, it is appreciated that any message sender may retrieve the recipients PK from K and encrypt the message prior to transmitting the message.

It is appreciated that one or more of the steps of any of the methods described herein may be omitted or carried out in a different order than that shown, without departing from the true spirit and scope of the invention.

It is appreciated that the methods and apparatus described herein may be implemented using computer hardware and/or software using conventional techniques.

While the present invention has been described with reference to one or more specific embodiments, the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

What is claimed is:

1. A peer-to-peer file distribution method comprising:
a) a buyer sending to a seller and an arbitrator a request to receive a file possessed by said seller;
b) said seller sending a confirmation of said request to said arbitrator;
c) said arbitrator sending encryption information to said seller;
said seller:
d) encrypting said file with said encryption information;
e) sending said encrypted file to said buyer;
f) creating a first hash from said encrypted file;
g) sending said first hash to said arbitrator;
said buyer:
h) creating a second hash from said encrypted file;
i) sending said second hash to said arbitrator;
if said hashes match, said arbitrator:
j) authorizing payment from said buyer to said seller;
k) sending decryption information to said buyer; and
said buyer decrypting said encrypted file.

2. A method according to claim 1 and further comprising:
in said sending step c) said arbitrator sending watermarking information to said seller;
in said encrypting step d) said seller watermarking said file with said watermarking information;
in said sending step e) said seller sending said encrypted and watermarked file to said buyer;
in said creating step f) said seller creating a first hash from said encrypted and watermarked file;
in said creating step h) said buyer creating a second hash from said encrypted and watermarked file.

3. A method according to claim 1 wherein any of said sending steps comprises encrypting that which is sent with an encryption key associated with the recipient of that which is sent.

4. A method according to claim 3 and further comprising any of the recipients of that which is sent in any of said sending steps decrypting that which is sent using a decryption key operative to decrypt that which is sent.

5. A method according to claim 1 wherein any of said sending steps comprises signing that which is sent with a signature key associated with the sender of that which is sent.

6. A method according to claim 5 and further comprising any of the recipients of that which is sent in any of said sending steps verifying the signature of that which is sent.

7. A computer program embodied on a computer-readable medium for peer-to-peer file distribution and comprising:
a code segment operative to send to a seller and an arbitrator a request to receive a file possessed by said seller;
a code segment operative to receive an encrypted file from said seller;
a code segment operative to create a hash from said encrypted file;
a code segment operative to send said hash to an arbitrator;
a code segment operative to receive decryption information sent from said arbitrator if said hash matches a second hash at said arbitrator; and
a code segment operative to decrypt said encrypted file using said decryption information.
